(19) United States
(12) Patent Application Publication
(10) Pub. No.: US 2006/0098676 A1
(43) Pub. Date: May 11, 2006

(54) Method and apparatus to facilitate macrodiversity reception

(75) Inventors: Zhijun Cai, N. Richland Hills, TX (US); Mansoor Ahmed, Fort Worth, TX (US); Robert M. Harrison, Grapevine, TX (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/983,400

(22) Filed: Nov. 8, 2004

(51) Int. Cl. H04J 3/26

(52) U.S. Cl. 370/432

(57) ABSTRACT

Separate Radio Network Controllers (11 and 13) exchange (31) neighboring cell information between one another. This information is used (32), in turn, to facilitate macrodiversity reception of multicast content. By one approach, a receiver node (16) receives this neighboring cell information which facilitates compatible reception of corresponding multicast content. The receiver node uses differing synchronization techniques (43 and 44) depending upon whether or not the multicast content is sourced by base stations that share a common Radio Network Controller. Pursuant to one technique having particular use when the base stations do not share a common Radio Network Controller, the receiver node compares the bearer content of at least one selected data block from one received multicast stream with the bearer content of a selected data block from another multicast stream.

### TECHNICAL FIELD

This invention relates generally to wireless communications and more particularly to macrodiversity transmission and reception.

### BACKGROUND

In ordinary course, wireless communications systems that provide telephony services tend to provide point-to-point communication links. It is also known, however, to provide multicast services where a plurality of receiving units each receives a streaming service such as a television broadcast program. In modern systems of this type, physical channels are often differentiated by use of different spreading codes (such as, for example, different Walsh codes). In general, it is desirable to maintain such multicast transmissions with as low a power as possible in order to minimize interference with other cell sites (which in turn typically permits maximized data throughput for the system).

One approach to maintaining reduced power levels is to employ macrodiversity reception techniques. Using macrodiversity in such a context, a signal is multicast from more than one base station. Upon receiving a plurality of signals that all represent the same source content, a receiving node can employ any of a variety of techniques to select and/or combine the received data to permit provision of a resultant received data stream that tends to more accurately track the original source content.

Macrodiversity techniques do give rise to new problems, however. As one example, the multicast transmissions as received from multiple base stations will typically not be well synchronized to one another. Fortunately, when all of the base stations in question are under the control of a common Radio Network Controller (RNC), these multiple transmission streams can be sufficiently synchronized to permit macrodiverse reception to be achieved. In particular, in some prior art systems the data blocks that comprise a multicast transmission each bear a sequence number of from 0 to 127 (with the sequence beginning anew each time upon reaching what would have been data block sequence number 128). Since a Radio Network Controller can typically successfully maintain the transmissions from its multiple base stations to within 64 data blocks of each other, these sequence numbers can usually serve as a basis to synchronize the various data block streams with one another to thereby permit macrodiversity processing.

Such an approach, however, does not necessarily meet all needs and requirements. For example, many systems may employ a plurality of Radio Network Controllers. While existing proposed solutions work adequately when applied to base stations that are under the common control of a single Radio Network Controller, these same solutions can be quite inadequate when applied in settings where multiple Radio Network Controllers are deployed. In such a case, the temporal disparity between multicast streams can and will vary to a greater extent than is otherwise likely in the case described above. When this occurs, the prior technique of using sequence numbers as a basis for establishing synchronicity can lead to unsatisfactory results.

### BRIEF DESCRIPTION OF THE DRAWINGS

The above needs are at least partially met through provision of the method and apparatus to facilitate macrodiversity reception described in the following detailed description, particularly when studied in conjunction with the drawings, wherein:

FIG. 1 comprises a block diagram as configured in accordance with various embodiments of the invention;

FIG. 2 comprises a block diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a flow diagram as configured in accordance with various embodiments of the invention;

FIG. 6 comprises a schematic view of data block streams as configured in accordance with various embodiments of the invention; and

FIG. 7 comprises a schematic view of data block content comparison as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, a first Radio Network Controller receives (or exchanges) neighboring cell information from (or with) a second Radio Network Controller. That first Radio Network Controller then uses that neighboring cell information to facilitate macrodiversity reception of content that is multicast by the first Radio Network Controller.

In a preferred approach, the receiving nodes are arranged and configured to receive such neighboring cell information and to use that information to inform and facilitate their own synchronization and macrodiversity reception activities. By one approach, such a receiving node can use a first technique to effect synchronization of multiple data block multicast streams (as when the multicast streams are sourced by base stations that are under the common control of a shared Radio Network Controller) and a second, different technique to effect synchronization of such streams when those streams are sourced by base stations that do not share a common Radio Network Controller.

In a preferred approach, the sequence numbers of the data blocks can be used to identify candidate data blocks and the bearer content of those candidate data blocks can then be compared with one another to ascertain their relative similarity or differences. Data blocks sharing a same sequence number and having substantially similar bearer content can then serve as a point of synchronization. A macrodiversity processing technique of choice can then be successfully employed as founded upon that point of synchronization.

So configured, system complexity can be relatively minimized—it is not necessary to somehow force or effect tight temporal synchronization between the transmissions of base stations as are controlled by different Radio Network Controllers. Instead, using relatively simple techniques and relying at least to some extent upon existing infrastructure and capabilities, the unsynchronized transmissions of such base stations can be readily and effectively synchronized to one another upon reception to then serve as a suitable basis for macrodiversity processing.

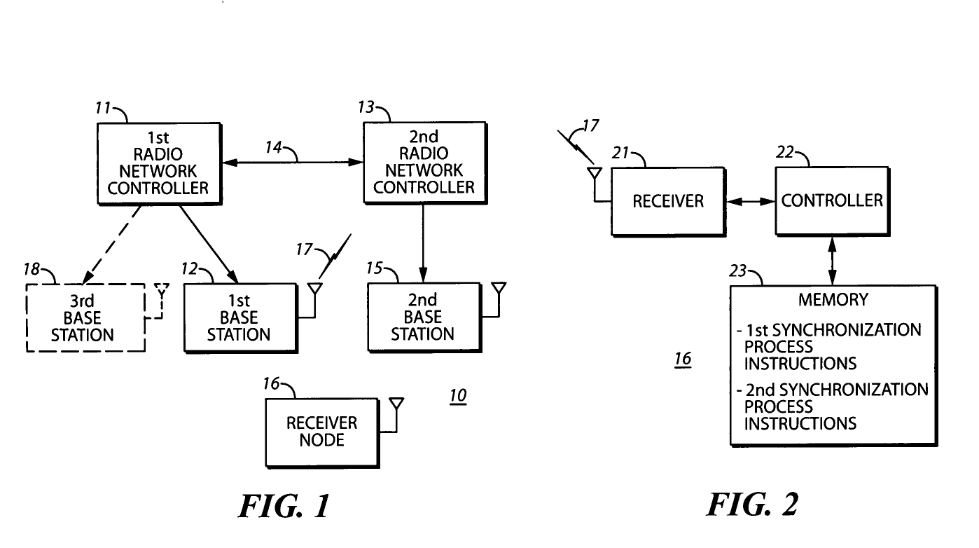

These and other benefits may become more evident upon making a thorough review and study of the following detailed description. Referring now to the drawings, and in particular to FIG. 1, for purposes of illustration these teachings are presented within the context of a Code Division Multiple Access (CDMA) cellular telephony wireless communication system 10 such as, but not limited to, CDMA2000, W-CDMA, Universal Mobile Telecommunications Service (UMTS), and the like. This system 10 comprises, in relevant part, a first Radio Network Controller 11 that controls at least a first base station 12 in accord with well understood prior art practice. This system 10 also comprises a second Radio Network Controller 13 that also serves to control at least a second base station 15. In this illustrative embodiment, the coverage areas as corresponds to these two base stations 12 and 15 comprise neighboring cells.

In a preferred implementation, this first and second Radio Network Controller 11 and 13 are communicatively coupled to one another via a corresponding communications link 14. Such a link 14 can be realized in any of a wide variety of ways, but in a preferred embodiment comprises an interface such as an lur link. Present lur links exist to permit communications between Radio Network Controllers though will require some minor protocol modification, well within the scope of those skilled in the art, to comport with the needs of these teachings.

In particular, these Radio Network Controllers 11 and 13 can use this link 14 to exchange, in a preferred approach, neighboring cell information. Such neighboring cell information can vary in accordance with the needs and capabilities of a given application, but in general will likely comprise at least Service identity information and/or Radio Bearer information. Since multiple macrodiversity transmission modes are often possible the radio bearer information will likely comprise the macrodiversity mode, and the periods of time during which the macrodiversity modes are used. As illustrative examples, two such macrodiversity modes can be:

1) When the information bits are identical, but the transmitted channel data bits are different; and

2) When both the information bits and transmitted channel data bits are identical.

The latter has been identified as “soft combining macro diversity,” and the former as “selection combining” in the context of W-CDMA standards. Soft combining and selection combining can be used at different times; furthermore the base stations that may be soft or selection combined may be different during different time intervals.

The times that different diversity modes can be used is therefore likely to be signaled to receiving units. Such information can be used, in a manner already understood by those skilled in the art, by a receiver node to facilitate compatible and successful reception of the transmissions of the base stations that comprise the neighboring cells.

So configured, and as will be described below in more detail, a receiver node 16 can receive multicast transmissions from both the first and second base station 12 and 15 in a manner that supports macrodiversity reception. Such functionality and capability may itself be facilitated, in a preferred approach, through use of a signal 17 as transmitted by one (or both) of the base stations, which signal 17 comprises an instruction or other indication that the receiver node 16 is to process these corresponding multicast transmissions using a synchronization technique (or techniques) such as those set forth herein rather than standard synchronization techniques as prevail today.

More particularly, such a signal 17 can serve to permit the use of one kind of synchronization technique by the receiver node 16 when receiving and processing multicast transmissions as sourced by inter-Radio Network Controller base stations 12 and 15 while also permitting the use of another kind of synchronization technique when receiving and processing multicast transmissions as sourced by intra-Radio Network Controller base stations such as the first base station 12 and a third base station 18 that is also controlled by the first Radio Network Controller 11.

With reference now to FIG. 2, the receiver node 16 can comprise, in relevant part, a receiver 21, a controller 22, and a memory 23. The receiver 21 can comprise, in a preferred approach, a receiver that is configured and arranged to compatibly receive the aforementioned signal 17. As but one example, this signal 17 can comprise an instruction message that is borne by a Control Channel as supported by the corresponding base station. The memory 23 will preferably have instructions as pertain to at least two synchronization processes stored therein. More particularly, the first synchronization process may be suitable to use when synchronizing two multicast transmissions as are sourced by base stations that are both associated with a common Radio Network Controller and the second synchronization process may be suitable to use when synchronizing two multicast transmissions as are sourced by base stations that are not both associated with a common Radio Network Controller. This memory can also serve to buffer incoming data streams while effecting the processes and techniques described herein.

With the controller 22 being operably coupled to both the receiver 21 and the memory 23, the controller can effect a first mode of operation wherein the first synchronization process is used to facilitate a macrodiversity reception process and a second mode of operation wherein the second synchronization process is used to facilitate the macrodiversity reception process. As will be shown below in more detail, the first synchronization process can comprise a standard known process whereas the second synchronization process can comprise, in a preferred embodiment, a comparison of the bearer content of at least one data block as comprises a first transmission from a first base station against the bearer content of at least one data block as comprises a second transmission from a second base station. Data block sequence numbers can serve to guide or inform selection of the particular data blocks to be so scrutinized.

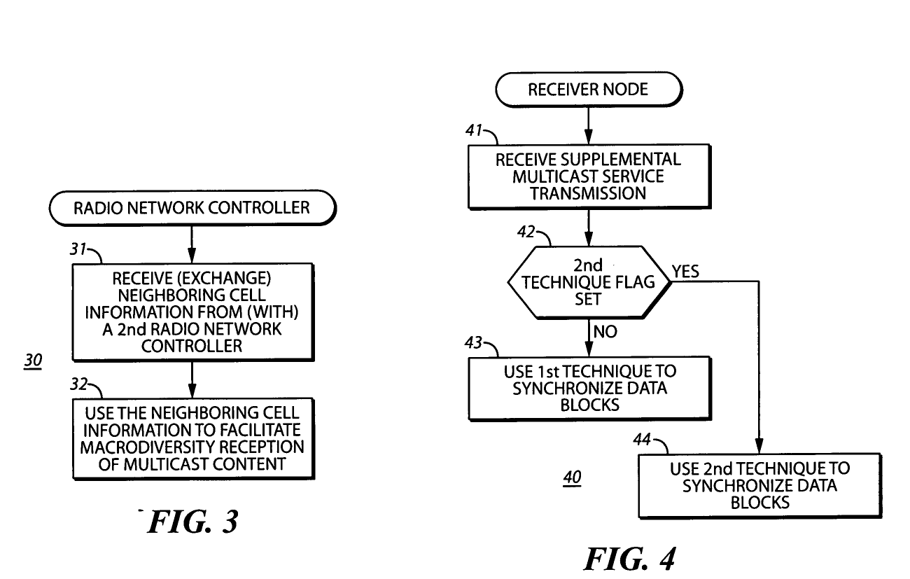

Referring now to FIG. 3, in a preferred approach a Radio Network Controller can be configured and arranged to effect a process 30 wherein the Radio Network Controller receives 31 (or, more preferably, exchanges) neighboring cell information from (or with) another Radio Network Controller. As noted above, this transaction can be borne via an appropriate interface between the two Controllers or via such other conveyance mechanism as may be preferred and/or available in a given setting. The Radio Network Controller then uses 32 this neighboring cell information to facilitate the macrodiversity reception of content being multicast by this Radio Network Controller (wherein the multicast comprises, for example, a Multimedia Broadcast/Multicast Service (MBMS) compatible broadcast). For example, the Radio Network Controller can cause at least one of its base stations to transmit at least some of the neighboring cell information to thereby permit a receiving node to use the neighboring cell information to receive a corresponding multicast transmission as is sourced by a base station that is responsive to the other Radio Network Controller (i.e., the Radio Network Controller that provided the indicated neighboring cell information).

As noted above, a base station may, in a preferred approach, broadcast (via, for example, a Control Channel) a signal that indicates to a receiving receiver node a need to use a particular synchronization technique. Referring now to FIG. 4, a corresponding receiver node process 40 provides for reception 41 of a multicast service transmission that is supplemental to another multicast transmission. For example, this supplemental multicast transmission may be sourced by another base station having an intra-Radio Network Controller or an inter-Radio Network Controller relationship with respect to a primary transmission. The receiver node can then determine 42 whether a second synchronization technique flag has been set (for example, upon receipt of the aforementioned signal as transmitted by a base station). In this absence of this flag, the receiver node uses 43 a first technique to synchronize its received data blocks (where, for example, the first technique comprises a known present-day synchronization technique). In the presence of this flag, however, the receiver node uses 44 its second synchronization technique to synchronize its received data blocks in order to effect its macrodiversity processing.

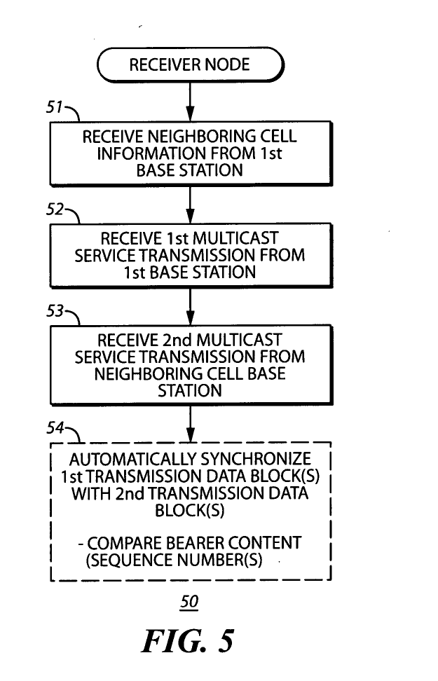

Viewed from another perspective, and referring now to FIG. 5, the receiver node receives 51 neighboring cell information from the first base station (or such other source as may be available and/or applied in a given application). Then, while receiving 52 a first transmission as corresponds to a multicast service transmission as transmitted by a first base station that is associated with a first Radio Network Controller (wherein the first transmission comprises, for example, at least one and preferably a plurality of data blocks), the receiver node can also compatibly receive 53 a second transmission as corresponds to the multicast service transmission as transmitted by a second base station that is associated with a second Radio Network Controller (wherein, again, the second transmission comprises, for example, at least one and preferably a plurality of data blocks).

Via this process 50 the receiver node then automatically synchronizes the data block (or data blocks) as comprise the first transmission with the data block (or data blocks) as comprise the second transmission. Pursuant to a preferred approach this synchronization occurs by comparing the bearer content of at least one data block from each transmission against one another. By one approach the sequence numbers as borne by these data blocks can be used to select the particular data blocks to be compared in this manner.

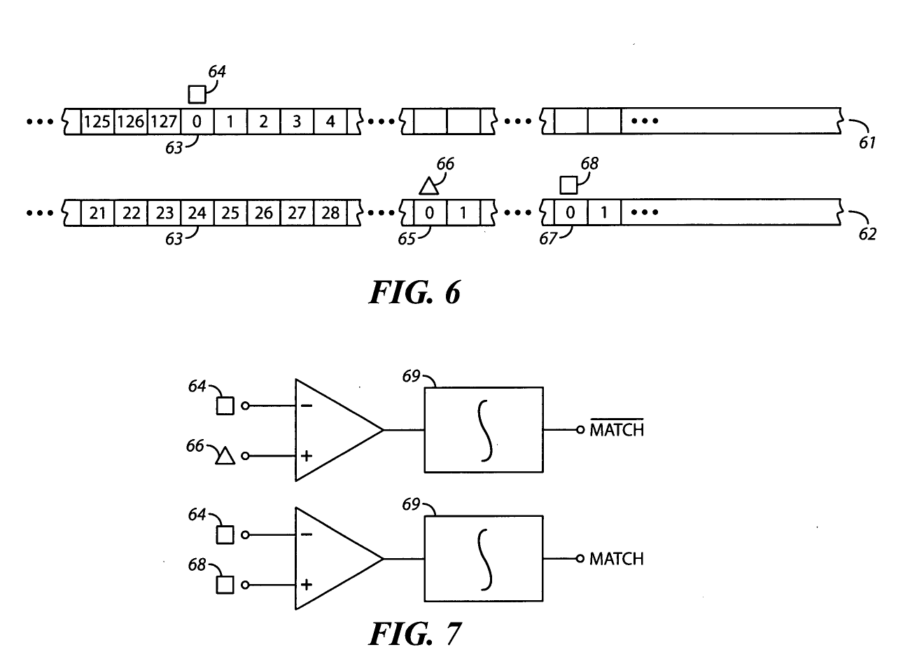

To illustrate, and referring now to FIG. 6, a first stream of data blocks 61 is seen to be comprised of data blocks having a repeating cycle of sequence numbers from 0 to 127. In a similar fashion a second stream of data blocks 62 (as received from another base station) is defined by a similar periodicity. As schematically represented in this figure, the sequence numbers for these two streams 61 and 62 are not temporally aligned. This, in turn, leads to ambiguity regarding, for example, which of the “0” sequence number data blocks 65 and 67 of the second stream 62 correlates to a given “0” sequence number data block 63 of the first stream 61. Pursuant to these teachings, the bearer content of selected data blocks are compared in order to confirm which of the second stream's data blocks bearing a given sequence number in fact correlates to a given data block of the first stream.

To illustrate, and presuming for the purpose of explanation that the “0” sequence number data blocks have been selected for this purpose, the bearer content 64 of a given one of the “0” sequence number data blocks 63 of the first stream 61 is compared against the bearer content 66 and 68 of various of the “0” sequence number data blocks 65 and 67 of the second stream. If desired, this comparison step can be repeated until a match is eventually identified. Referring now to FIG. 7, when the bearer content (such as the bearer content represented by reference numerals 64 and 66) fails to correlate to at least some predetermined degree of correspondence (typically over some period of time and some plurality of received symbols as are captured and represented through corresponding integration 69), a non-match conclusion can be drawn and the process can continue the comparison process against other data blocks to seek a match. This process of correlating bearer content can be done at various points in the receive process. Correlating the bearer content can comprise, for example, correlating the decoded bits, the received channel bits, or the received channel symbols. When the bearer content (such as the bearer content represented by reference numerals 64 and 68) does correlate to some acceptable degree, however, the match is noted and synchronization between the two streams 61 and 62 is realized. Macrodiversity reception processing can then proceed in accord with present (or hereafter-developed) practice.

So configured, those skilled in the art will appreciate that synchronicity can be readily established as between two or more temporally unsynchronized streams of data blocks in a multicast context notwithstanding a relative lack of significant system alterations or overhead requirements. Furthermore, such synchronization techniques need only be applied when needed. In the illustrative examples provided above, the receiver node is effectively instructed by the base station to implement the described synchronization technique. If desired, however, selection of the described technique can be effected in other ways. For example, poor macrodiversity results as noted by the receiver node can serve in and of themselves to prompt automated selection and trial usage of these synchronization techniques. When successfully employed, the usage can persist for some period of time or until some other signal or indicia prompts an alternative action.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one of many examples, in the illustrations provided above the data blocks of the secondary data block stream lagged the data blocks of the primary data block stream. The opposite may occur, however, and it may be useful to employ a hunt strategy that expands a search for the correct sequence number data block in alternating temporal directions with respect to an origin data block in the first stream. It would also be possible to require a match of the bearer content between an increased number of data blocks to provide greater assurance that synchronization has indeed be achieved. Furthermore, the use of sequence numbers for synchronization is not required in systems that do not use them. In such cases the data blocks may be assumed to be transmitted from all base stations in a fixed order, and comparisons of sequence numbers can be omitted. Additionally, the radio network controller may be part of the base station, and may only control that base station's function.

We claim:

1. A method for use by a first Radio Network Controller comprising:
receiving neighboring cell information from a second Radio Network Controller;
using the neighboring cell information from the second Radio Network Controller to facilitate macrodiversity reception of content being multicast by the first Radio Network Controller.

2. The method of claim 1 wherein receiving neighboring cell information from a second Radio Network Controller comprises receiving the neighboring cell information via an interface between Radio Network Controllers.

3. The method of claim 1 wherein receiving neighboring cell information from a second Radio Network Controller further comprises exchanging neighboring cell information with the second Radio Network Controller.

4. The method of claim 1 wherein using the neighboring cell information from the second Radio Network Controller to facilitate macrodiversity reception of content being multicast by the first Radio Network Controller further comprises causing at least one base station to transmit at least some of the neighboring cell information to thereby permit a receiving node to use the neighboring cell information to receive a corresponding multicast transmission as is sourced by a base station that is responsive to the second Radio Network Controller.

5. The method of claim 1 wherein the neighboring cell information comprises at least:
Service identity
Radio Bearer information.

6. The method of claim 5 wherein the Radio Bearer information comprises at least:
an indication of a macrodiversity mode with which a service identified by the Service identity will be transmitted;
an indication of a time interval during which the macrodiversity mode will be used.

7. The method of claim 1 wherein the multicast comprises a Multimedia Broadcast/Multicast Service (MBMS) compatible multicast.

8. A method for use by a receiver node to facilitate use of macrodiversity when receiving a multicast service transmission, comprising:
receiving a first transmission as corresponds to the multicast service transmission as transmitted by a first base station that is associated with a first Radio Network Controller, wherein the first transmission comprises at least one data block;
receiving a second transmission as corresponds to the multicast service transmission as transmitted by a second base station that is associated with a second Radio Network Controller, wherein the second transmission comprises the at least one data block.

9. The method of claim 8 wherein receiving a second transmission further comprises:
receiving neighboring cell information from the first base station that facilitates reception of the second transmission.

10. The method of claim 9 wherein receiving neighboring cell information from the first base station further comprises receiving neighboring cell information from the first base station via a Control Channel.

11. The method of claim 8 and further comprising:
automatically synchronizing a plurality of the at least one data block as comprises the first transmission with a plurality of the at least one data block as comprises the second transmission.

12. The method of claim 11 wherein automatically synchronizing the plurality of at least one data block as comprises the first transmission with the plurality of at least one data block as comprises the second transmission further comprises comparing bearer content of at least one of the plurality of the at least one data block as comprises the first transmission against bearer content of at least one of the plurality of the at least one data block as comprises the second transmission.

13. The method of claim 12 wherein comparing bearer content of at least one of the plurality of the at least one data block as comprises the first transmission against bearer content of at least one of the plurality of the at least one data block as comprises the second transmission further comprises comparing bearer content of at least one of the plurality of the at least one data block as comprises the first transmission against bearer content of at least one of the plurality of the at least one data block as comprises the second transmission as a function, at least in part, of sequence numbers of the data blocks.

14. The method of claim 8 and further comprising:
receiving a third transmission as corresponds to the multicast service transmission as transmitted by a third base station that is associated with the first Radio Network Controller, wherein the third transmission comprises a plurality of data blocks;
using a first technique to synchronize the plurality of the at least one data block of the first transmission with the third transmission;
using a second technique to synchronize the plurality of the at least one data block of the first transmission with the second transmission, which second technique is different from the first technique.

15. The method of claim 14 wherein using the second technique further comprises:
receiving a signal indicating a need to use the second technique.

16. The method of claim 15 wherein receiving a signal further comprises receiving the signal from the first base station.

17. An apparatus comprising:
a receiver;
a memory having stored therein:
instructions regarding a first synchronization process to use when synchronizing two multicast transmissions as are sourced by base stations that are both associated with a common Radio Network Controller;
instructions regarding a second synchronization process to use when synchronizing two multicast transmissions as are sourced by base stations that are not both associated with a common Radio Network Controller;
a controller operably coupled to the receiver and the memory and having a first mode of operation wherein the first synchronization process is used to facilitate a macrodiversity reception process and a second mode of operation wherein the second synchronization process is used to facilitate the macrodiversity reception process.

18. The apparatus of claim 17 wherein:
the receiver further comprises a first signal receiver; and
the controller is responsive to the first signal such that selection of the first mode and the second mode of operation is dependent, at least in part, upon reception of the first signal.

19. The apparatus of claim 18 wherein the controller further comprises means for effecting the second synchronization process by comparing bearer content of at least one data block as comprises a first transmission from a first base station against bearer content of at least one data block as comprises a second transmission from a second base station.
